(19) United States
(12) Patent Application Publication
(10) Pub. No.: US 2016/0236908 A1
(43) Pub. Date: Aug. 18, 2016

(54) ELEVATOR DOOR ARRANGEMENT

(71) Applicant: Tapani TALONEN, Tervakoski (FI)

(72) Inventor: Tapani TALONEN, Tervakoski (FI)

(73) Assignee: Kone Corporation, Helsinki (FI)

(21) Appl. No.: 15/010,534

(22) Filed: Jan. 29, 2016

(30) Foreign Application Priority Data
Feb. 12, 2015 (EP) 15154881.5

(51) Int. Cl. B66B 13/30; B66B 13/08

(52) U.S. Cl. CPC B66B 13/303; B66B 13/08

(57) ABSTRACT

The invention refers to an Elevator door arrangement having at least one door leaf comprising a support structure and at least one door panel having a back part facing away from the public and a front part facing the public, which door panel is supported in the support structure of the door leaf. The door panel is configured to be supported in the support structure either with its back part or front part facing the public, as desired. This invention allows a protected use of a door panel during construction time use.

This application claims priority to European Patent Application No. 1514881.5 filed on Feb. 12, 2015, the entire contents of which are incorporated herein by reference.

### BACKGROUND OF THE INVENTION

The present invention relates to an elevator door arrangement which is used for the elevator car and/or for the landing doors in the different floors. Usually, these doors are automatic doors having at least two door leafs which are driven usually by the door drive of the elevator car in the same direction if the door opens to the side or in opposite directions when it opens centrally. Each door leaf of the elevator door has at least one door panel supported by door support structure in a door supporter of the elevator car or elevator shaft. Usually, this support structure comprises at the top of the door panels a door hanger with running tracks on a door supporter mounted on the elevator car as well as on the elevator shaft walls. The door panels are e.g. via door hangers provided with rollers riding in said tracks of the door supporter. On the bottom side the door panels usually have vertical bolts or rollers running around a vertical axis running in a groove of a door sill of the elevator car or landing access. The door panel has a back part forming its back side facing away from the public and a front part forming its front side facing the front, i.e. facing the passengers. The front- and back part may be separate parts or may be embodied as the front side and back side of one and the same part. One problem with these doors appears during construction time work during which the usually decorative front part, for example a stainless steel front of the door panel may be damaged. On this behalf, often construction time panels are used to avoid the damaging of the door panels, particularly of their decorative front part.

### SUMMARY OF THE INVENTION

It is therefore object of the present invention to provide an elevator door arrangement which facilitates the construction time use and minimizes the danger of damaging the front part of the door panels.

The object of the invention is solved with an elevator door arrangement according to claim 1. Preferred embodiments of the invention are subject-matter of the corresponding dependent claims. Some inventive embodiments are also discussed in the descriptive section of the present application and in the drawings. The inventive content may also consist of several separate inventions, especially if the invention is considered in the light of expressions or implicit sub-tasks or from the point of view of advantages achieved. In this case, some of the attributes contained in the claims below may be superfluous from the point of view of separate inventive concepts. Likewise, the different details presented in connection with each embodiment of the invention can also be applied in other embodiments. In addition, it can be stated that at least some of the dependent claims can in at least some situations be deemed to be inventive in their own right.

According to the invention, the door panel is configured to be supported in the door support structure of the door supporter either with a back part or with its front part facing the front, i.e. the public, as desired. This configuration of the support structure and the door panels to support the door panels either back part front or front part front enables the elevator technicians to mount the door panels during a construction time use back part front in the support structure so that the decorative front part of the door panels is safe from being damaged by construction workers. After the construction time use has been finished, the door panels can be released from the support structure and turned around to be mounted front part front in the support structure, particularly door hanger of a door supporter. Now the decorative side of the door panel faces the public as it is desired for normal use.

The door panels may have connected or separated back parts and front parts so that during the change the back and front parts of different door leaves may mixed or exchanged. That means that after the change a door leave may have a front part of the door panel which was in located another door leaf beforehand.

To be able to turn the door panels in the support structure back part front or front part front, they are preferably releasably supported in the support structure. Thus, the door hanger, i.e. the connection between the door panel and the door supporter in the top part of the door panel may be releasably connected to the door panel such that the door roller are either facing to the front or backside of the door panel. The releasable connection may be realized as form fit or snap fit connection.

In a preferred embodiment of the invention, the door panel has a symmetrical structure with respect to its central plane which facilitates the turning of the door panel in the support structure to be fitted front part front or back part front. In this case the support structure parts connected to the door panel, i.e. door hangers at the top and guide rollers or guide bolts at the bottom are then located in the central plane of the door panel which leads to identical positions and dimensions of the mounted door panel irrespective of its orientation in the support structure.

Preferably, the front part of the door panel is covered by a protective film. Via this measure it is further ensured that even during the support of the door panel in the support structure with its front part back, no damage occurs to the front part of the door panel, particularly in its edge reasons where it may still face the passengers, when the front part embraces the door panel edges.

Preferably, the back part of the door panel comprises or consists of an insulating material which leads to a better insulation of the landing to the car shaft and of the elevator car to the elevator shaft, whereby different kinds of insulation are preferably realised, such as fire insulation, noise insulation and insulation against cold and heat. With regard to fire insulation the door leaf consisting of the front part and back part is designed and certified to be fire insulating in both directions.

In a preferred embodiment of the invention, the elevator door has at least two slidable door leafs driven by a car door drive with different velocities. This kind of elevafor doors is usually used for the elevator car as well as for the landings with a larger opening. Hereby usually the door leafs of the landing door where the elevator has stopped as well as the door leafs of the car door are moved by one door drive mounted at the elevator car.

The parts of the support structure mounted to the door panel may be e.g. door hangers at the top of the door panel and/or guide bolts or rollers extending from the bottom of the door panel. These parts may be mounted on plates connected to the door panel. For symmetrical mounting of the door panel it is preferred if these door panel related parts of the support structure are mounted to extend in the central plane of the door panel (parallel to or in the door plane).).

Preferably the door leaf comprises a fixing structure to which the front part and back part of the door leaf are mounted. Preferably all parts relating the support and/or closing/locking mechanism of the elevator door are mounted to said fixing structure, so that these parts are unaffected from the flipping of the front and back part of the door leaf. This fixing structure could comprise a frame or upper and lower beams or other kind of a carrier structure that is not flipped when the front part and back part of the door panel are exchanged of the door panel with its front and back part is simply flipped. Particularly, any coupling and ramp system that couples landing and car doors is arranged in connection with the fixing structure of the door leaf. This system could be fixed preferably to a frame or beam of the fixing structure that does not rotate when the panels are flipped. As a matter of fact, the door panel could be just simply a panel whereby the front part and back part are formed by the front side and back side of said door panel. This door panel that can be fixed to the fixing structure, e.g. to a frame structure or beams thereof.

In the invention the term construction time use includes renovations, modernizations or normal use in which the front parts of the door panels shall be protected (e.g. when a party residing in the building is moving in and/or out).

At the bottom side of the door panel this may be at least one guide element, e.g. guide roller or guide bolt configured to run in a groove of a door sill, which guide element is preferably located in the central door plane. In this case, the turning of the door panel in the support structure leads to the same geometrical configuration and mutual arrangement of the door panels of the different door leaves of the elevator door(s).

The invention also relates to an elevator car having an automatic car door as described above as well as an elevator comprising at least one elevator car having a car door as described above and/or several landing doors as described above. Particularly, the invention also relates to an elevator having at least one elevator car with at least one car door with two slidable door leafs and landing doors with two slidable door leafs at each serviced floor, whereby the door leafs of the car door and landing doors are operated by one door drive mounted at the elevator car.

It is clear for the skilled person that the above-mentioned embodiments can be combined with each other arbitrarily.

### BRIEF DESCRIPTION OF THE DRAWINGS

The invention is now described by means of an example in the enclosed drawings. In these drawings

FIG. 1 shows a horizontal cross-section through a door arrangement having a car door and landing door during construction time use, and

FIG. 2 a horizontal section through the door arrangement according to FIG. 1 during normal use of the elevator.

### DESCRIPTION OF THE PREFERRED EMBODIMENTS

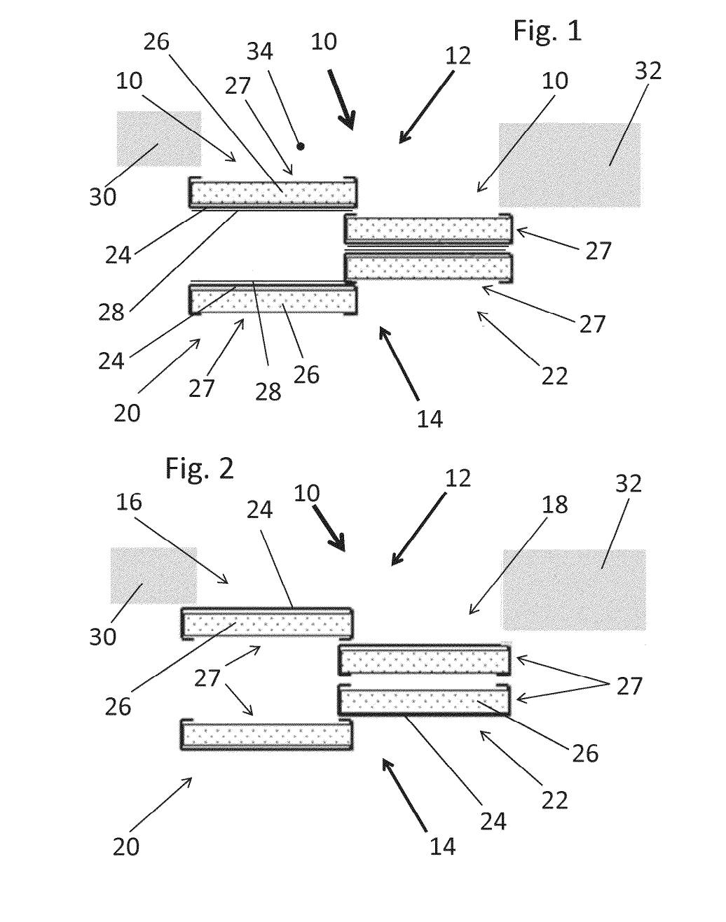

FIG. 1 shows an elevator door assembly 10 having a landing door 12 and a car door 14 which are commonly driven by one car door drive. The landing door 12 comprises two door leafs 16, 18 and also the car door 14 comprises two door leafs 20, 22 whereby the two door leafs 16, 18 of the landing door and 20, 21 of the car door 14 are slidably in horizontal direction whereby telescopically first the distal door leafs 18, 22 and afterwards the proximal door leafs 16, 20 of the landing door 12 and car door 14 are moved. Each door leaf 16, 18, 20, 22 comprises a door panel 27 and parts of a support structure (not shown) by which the corresponding door panel 27 is guided, e.g. in a track of an upper door supporter as well as in the groove of a door sill. These parts may be e.g. door hangers at the top of the door panel and/or guide bolts or rollers extending from the bottom of the door panel. These parts may be mounted on plates connected to the door panel. For symmetrical mounting of the door panel it is preferred if these door panel related parts are mounted to the central plane of the door panel in the door plane.

The door panel 27 has a front part 24 which is covered during construction time use with a protective foil 28, which front part forms during normal use of the elevator the front facing the passengers. The door panel 27 further has a back part 26 which preferably consists of or comprises a noise insulating material for a better ride comfort in the elevator car. The front part preferably consists of a sheet metal plate of stainless steel or any other decorative material and preferably covers or embraces the edges of the door panel 27 as it can be seen in the drawing. During construction time use the protective foil 28 also covers these edge regions of the front parts 24 which may face the passengers also during construction time use.

This construction principle of a door panel 27 holds true for each of the door leafs 16, 18, 20, 22 of the car door 14 and landing door 12. It has to be mentioned that the car door 14 and landing door 12 arrangement 10 shown in the figures opens to the side. The same construction principle may also be used in a centrally opening car door and landing door arrangement.

FIG. 1 shows the door arrangement 10 during the construction time use where the back part 26 of each door panel 27 faces the public which has the effect that the front part 24 of the door panel 27 cannot be damaged which may easily happening when construction workers carry tools and other components of the elevator in and out of the elevator car. As the edge regions of the front parts which may still face the public are covered by a protective foil even these parts are still protected somewhat against damage.

FIG. 2 shows the door arrangement 10 of FIG. 1 during normal use of the elevator, e.g. after the construction time use has been finished. According to the invention, the door panels 27 are turned around in the support structure (not shown) so that their front part 24 which also cover the edges of the door panel 27 of the corresponding door leafs 16, 18, 20, 22 is facing the front, i.e. the public. Thus, the front part 24 and back part 26 of each door panel 27 is oriented in a way as intended for normal use, wherein the decorative front part 24 is seen from all directions visible from the public whereas the noise insulating back part 26 faces to the back of each door panel 27 facing away from the public and only carries its function as construction part and noise insulating part. Based on the protective mounting of the door panels in FIG. 1 the decorative front parts 24 have a much higher probability to remain undamaged during construction time use.

Both figures furthermore show a first part 30 and a second part 32 of an elevator shaft wall whereby between these parts a landing access 34 is formed which is closed on the landing side by the landing door 12.

The invention is not restricted to the above embodiments but may be varied within the scope of the appended patent claims.

### LIST OF REFERENCE NUMBERS

10 door arrangement
12 landing door
14 car door
16 first landing door leaf
18 second landing door leaf
20 first car door leaf
22 second car door leaf
24 front part of door panel
26 back part of door panel
27 door panel
28 protective foil
30 first shaft wall part
32 second shaft wall part
34 landing access

1. Elevator door arrangement having at least one door leaf comprising at least one door panel having a back part facing away from the public and a front part facing the public, which door panel is configured to be supported in a support structure of a door supporter mounted at the elevator car or elevator shaft wall, characterized in that the door panel is configured to be supported in the support structure either with a back part or front part front, as desired.

2. Elevator door arrangement according to claim 1, wherein the door panel is releasably supported in the support structure.

3. Elevator door arrangement according to claim 1, wherein the door panel has a symmetrical structure with respect to its central plane.

4. Elevator door arrangement according to claim 1, wherein the front part embraces the edges of the door panel.

5. Elevator door arrangement according to claim 1, wherein the front part is temporarily covered by a protective film.

6. Elevator door arrangement according to claim 1, wherein the back part comprises or consists of an insulating material.

7. Elevator door arrangement according to claim 1, wherein it has at least two slidable door leaves driven by a car door drive in opposite directions.

8. Elevator door arrangement according to claim 1, wherein the front part consist of a stainless steel plate.

9. Elevator door arrangement according to claim 1, wherein the door panel carries at its upper side at least one door hanger having rollers for running in a track of a door supporter, whereby the door hanger is preferably mountable to the door panel in two positions differing at 180 degrees around a vertical axis.

10. Elevator door arrangement according to claim 1, wherein the door panel carries at its bottom side at least one guide element, e.g. guide roller or guide bolt configured to run in a groove of a door sill, which guide element is preferably located in the central door plane.

11. Elevator door arrangement according to claim 1, wherein the door leaf comprises a fixing structure to which the front part and back part of door panel is/are mounted.

12. Elevator door arrangement according to claim 11, wherein support elements and/or drive elements and/or door lock elements of the door leaf are mounted to the fixing structure.

13. Elevator car having at least one car door arrangement according to claim 1.

14. Elevator having at least one door arrangement according to claim 1 at its elevator car and/or at its landings.

15. Elevator according to claim 14, having a an elevator car with at least one car door with two slidable door leaves and landing doors with two slidable door leaves at each serviced floor, whereby the door leaves of the car door and landing door are operated by one door drive mounted at the elevator car.

16. Use of an elevator door arrangement according to claim 1, wherein during a construction time use the door panels of a car door and/or landing door are supported by the support structure with their back part front and that with the finishing of the construction time use the door panels are released from the support structure, turned around and fixed to the support structure with their front part front.
